(19) United States
(12) Patent Application Publication
(10) Pub. No.: US 2018/0112781 A1
(43) Pub. Date: Apr. 26, 2018

(54) BLOCK FOR FLUID CONVEYANCE DEVICE

(71) Applicant: 2141632 Ontario Inc., Ingersoll (CA)

(72) Inventors: Stephan Ernst Bohner, Woodstock (CA); Arben Mema, London (CA); Dick Law Dykxhoorn, London (CA)

(21) Appl. No.: 15/793,015

(22) Filed: Oct. 25, 2017

Related U.S. Application Data
(60) Provisional application No. 62/413,158, filed on Oct. 26, 2016.

(51) Int. Cl. F16K 5/06; F16K 27/12; F16L 19/00

(52) U.S. Cl. CPC F16K 5/0647; F16K 27/12; F16D 2121/24; F15B 2211/528; F15B 2211/7107; F16L 19/005

(57) ABSTRACT

A block for a fluid conveyance device (e.g. a hydraulic pump or motor) has a spindle mountable on an outlet face of a housing of the device. The spindle has a spindle fluid conduit in fluid communication with a housing outlet on the outlet face of the housing. A barrel is mounted on the spindle, the barrel having a barrel fluid conduit in fluid communication with the spindle fluid conduit. The barrel fluid conduit has a fluid outlet port oriented at an angle in a range of about 10-170° with respect to direction of fluid flow from the housing into the spindle fluid conduit. The barrel may be mounted on the spindle in a plurality of configurations, the fluid outlet port pointing in a different direction in each configuration of the barrel. The block provides the ability to direct hoses to a desired location while reducing the likelihood of failure of any given fitting on the device.

### CROSS-REFERENCE TO RELATED APPLICATIONS

This application claims the benefit of U.S. Provisional Patent Application Ser. No. 62/413,158 filed Oct. 26, 2016, the entire contents of which is herein incorporated by reference.

### FIELD

This application relates to fluid conveyance devices and blocks therefor.

### BACKGROUND

Fluid conveyance devices, e.g. pumps and motors such as hydraulic pumps or motors, are normally equipped with a threaded outlet port in the center of a face of the device in which a threaded straight fitting or a threaded elbow fitting is threaded. Hoses, e.g. hydraulic hoses, are attached to the fitting to carry fluid from the device to a remote location, for example to a hydraulic work tool. Such an arrangement provides limited ability to direct the hoses where required.

In addition, the straight or elbow fitting endures much stress resulting from the fluid leaving the device at a pressure in excess of about 5000 psi. Because the fluid being conveyed is often pulsing, further stress is placed on the fitting. Such stresses lead to fitting failure (e.g. leaks and/or breakage).

Further, because the hoses, especially hydraulic hoses, may become very stiff under pressure (i.e. the hoses become more like pipes), any axial load provided by attachments, e.g. an attached work tool, is transferred back to the fitting at the device, which further stresses the fitting leading to an even greater likelihood of fitting failure.

There remains a need for a fluid conveyance device that provides increased ability to direct hoses to desired locations while reducing the likelihood of fitting failure due to stresses on the fitting.

### SUMMARY

In one aspect, there is provided a block for a fluid conveyance device, the block comprising: a spindle mountable on an outlet face of a housing of a fluid conveyance device, the spindle having a spindle fluid conduit in fluid communication with a housing outlet on the outlet face of the housing; and, a barrel mounted on the spindle, the barrel comprising a barrel fluid conduit in fluid communication with the spindle fluid conduit, the barrel fluid conduit having a fluid outlet port, the fluid outlet port having a central axis parallel to fluid flow through the fluid outlet port, the central axis of the fluid outlet port oriented at an angle in a range of about 10-170° with respect to direction of fluid flow from the housing of the fluid conveyance device into the spindle fluid conduit, the barrel mountable on the spindle in a plurality of configurations, the central axis of the fluid outlet port pointing in a different direction in each configuration of the barrel.

In another aspect, there is provided a fluid conveyance device comprising the block of the present invention.

In another aspect, there is provided a fluid conveyance device comprising: a fluid conveying mechanism contained in a housing, the housing having a housing outlet for fluid situated on an outlet face of the housing; and, a block comprising a spindle and a barrel, the spindle mounted on the outlet face, the spindle having a spindle fluid conduit in fluid communication with the outlet, the barrel mounted on the spindle, the barrel comprising a barrel fluid conduit in fluid communication with the spindle fluid conduit, the barrel fluid conduit having a fluid outlet port, the fluid outlet port having a central axis parallel to fluid flow through the fluid outlet port, the central axis of the fluid outlet port oriented at an angle in a range of about 10-170° with respect to direction of fluid flow through the housing outlet into the spindle fluid conduit, the barrel mountable on the spindle in a plurality of configurations, the central axis of the fluid outlet port pointing in a different direction in each configuration of the barrel.

The fluid conveyance device may be, for example, a pump or motor. In some embodiments, the fluid conveyance device may be a hydraulic pump or hydraulic motor.

In one embodiment, the spindle may be pre-tensioned under a pre-tensioning force. The pre-tensioning force may be at least equivalent to a total induced load on the device, the total induced load arising at least in part from fluid pressure in the device and mechanical loads on the device. Because the spindle is pre-tensioned with a force equal to or exceeding the forces arising during operation of the fluid conveyance device, the spindle does not experience the induced load thereby reducing stresses on the fittings of the device thereby reducing the likelihood of fitting failure. The pre-tensioning force is preferably at least three times the fluid pressure in the spindle fluid conduit multiplied by the area of a distal end of the spindle fluid conduit on which the fluid flowing in the spindle fluid conduit impinges.

In one embodiment, the barrel is rotatably mounted on the spindle. Rotating the barrel on the spindle may change the configuration of the barrel to change an angular position of the fluid outlet port on the block. In another embodiment, the barrel is removably mounted on the spindle. The barrel may be rotatably and/or removably mounted on the spindle by a locking plate. The locking plate may be reversibly securable to the spindle. The locking plate may be fixedly securable to the spindle to immovably lock the barrel between the locking plate and an abutment portion of the spindle. The locking plate may also provide the pre-tensioning force when the locking plate is fixedly secured to the spindle. The locking plate may be loosenable from the spindle to permit rotation of the barrel on the spindle. The locking plate may be removable from the spindle to permit removal of the barrel from the spindle.

In an embodiment, the spindle may comprise a distal face to which the locking plate is securable, for example by threaded pins. The locking plate may have an outer portion extending radially beyond a perimetrical edge of the distal face. The barrel may be secured between the outer portion of the locking plate and the abutment portion of the spindle when the locking plate is fixedly secured to the spindle. The spindle and the locking plate may be separated by a gap when the locking plate is fixedly secured to the spindle. The barrel may have a distal face that extends longitudinally beyond the distal face of the spindle, thereby creating the gap between the spindle and the locking plate.

In an embodiment, the spindle may comprise a proximal face having a spindle inlet port in fluid communication with the spindle conduit. The spindle inlet port may be configured to align with the housing outlet on the outlet face of the housing to fluidly communicate with the outlet face on the housing when the proximal face of the spindle abuts the outlet face of the housing.

In an embodiment, the barrel comprises a barrel outlet face in which the fluid outlet port may be situated. The barrel outlet face may have a non-zero angle relative to the proximal face of the spindle.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A is a perspective view of a pump block in accordance with one embodiment of the present invention;

FIG. 1B is a rear face view of the pump block of FIG. 1A;

FIG. 1C is a side view of the pump block of FIG. 1A;

FIG. 1D is a front face view of the pump block of FIG. 1A;

FIG. 1E is a longitudinal sectional view of the pump block of FIG. 10 taken through section A-A;

FIG. 1F is a longitudinal sectional view of the pump block of FIG. 10 taken through section A-A, showing fluid flow axes and angles between the fluid flow axes.

FIG. 2A, FIG. 2B and FIG. 2C are transverse sectional views through the pump block of FIG. 1A showing a barrel rotated a different angular positions with respect to a spindle, the pump block mounted on a housing of a pump;

FIG. 3A is a perspective view of a hydraulic pump comprising a pump block of the present invention mounted on a housing of the pump; and,

FIG. 3B is a perspective view of the hydraulic pump of FIG. 3A showing the pump block separated from the housing.

### DETAILED DESCRIPTION

With reference to the Figures, a pump block 1 is illustrated comprising a spindle 2 and a barrel 20 mounted on the spindle 2.

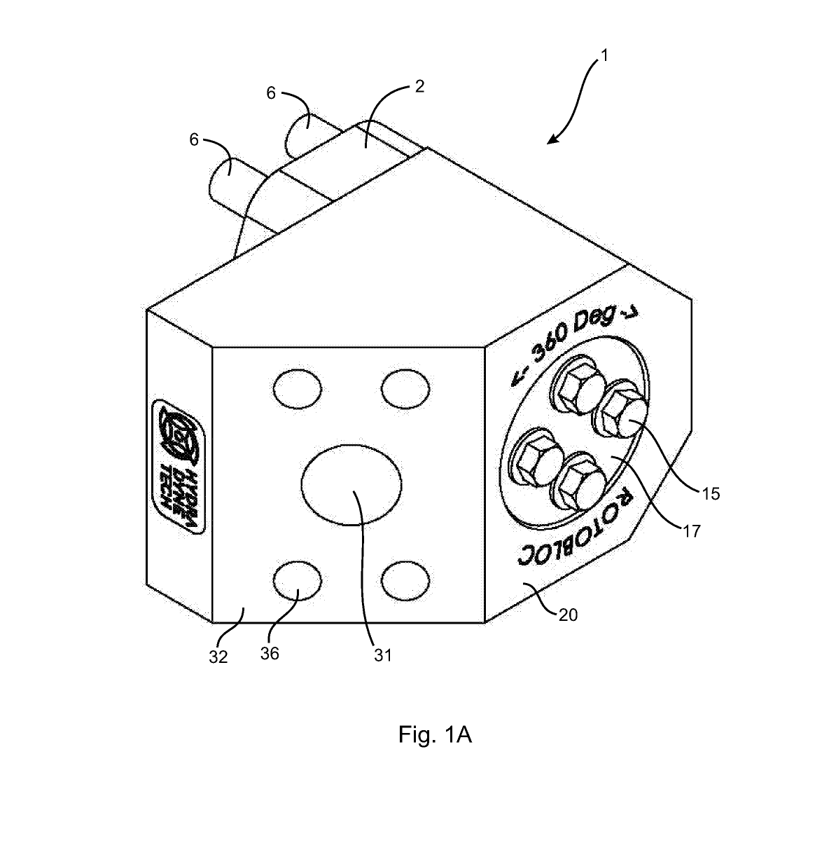

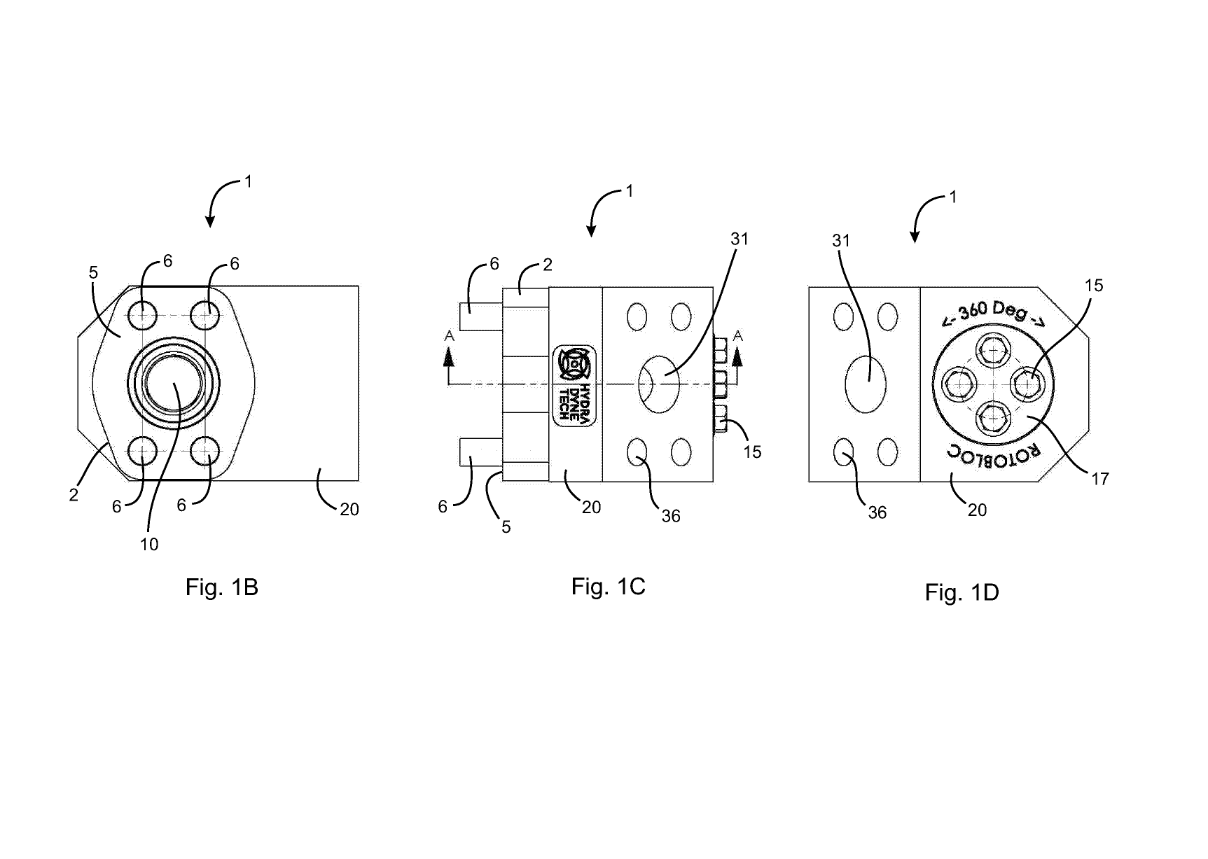

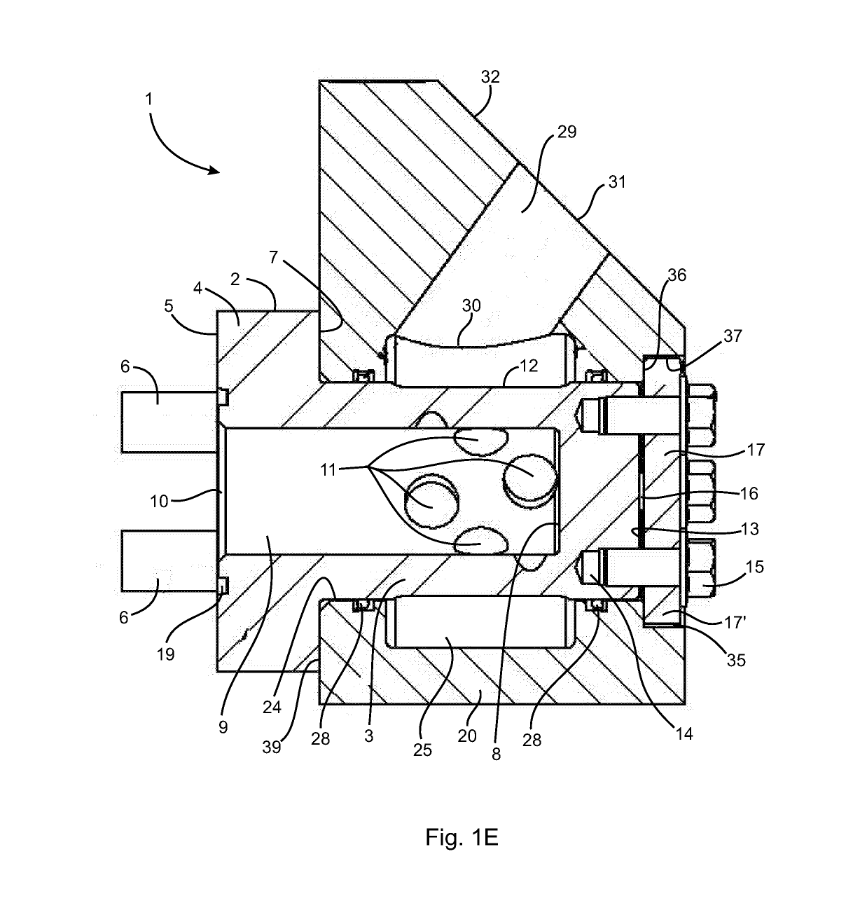

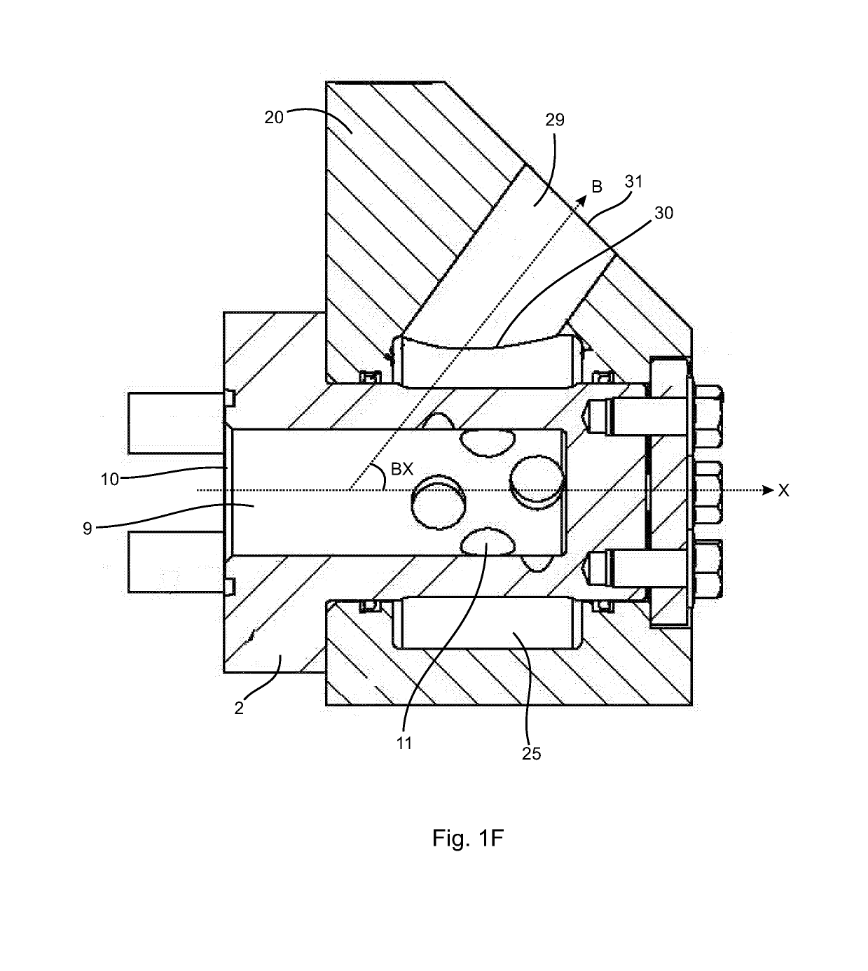

The spindle 2 may comprise a generally annular barrel support portion 3 on which and around which the barrel 20 is supported, and a generally annular abutment portion 4 protruding radially with respect to the barrel support portion 3, the barrel 20 abutting an abutment surface 7 of the abutment portion 4 to prevent further relative longitudinal movement of the barrel 20 toward a proximal end of the spindle 2. The proximal end of the spindle 2 comprises a spindle inlet face 5 having a spindle inlet port 10 situated thereon, preferably centrally located on the spindle inlet face 5. Protruding longitudinally from the spindle inlet face 5 may be one or a plurality of mounting pins 6 (e.g. four as shown in FIG. 1B), which may facilitate mounting the spindle 2 on a housing of a hydraulic pump.

The spindle 2 further comprises a spindle conduit 9 disposed inside the spindle 2. The spindle conduit 2 may be of any cross-sectional shape (e.g. circular, elliptical, polygonal), however a generally circular cross-sectional shape is preferred. The spindle conduit 9 terminates at the spindle inlet port 10 at the proximal end of the spindle 2, and opens into one or a plurality of spindle outlet ports 11 proximate a distal end of the spindle 2. The spindle outlet ports 11 may open out on a radial surface 12 of the barrel support portion 3. While the spindle conduit 9 may follow any path through the spindle 2, the spindle conduit 9 preferably follows a straight path along an axis parallel to a longitudinal axis of the spindle 2, as shown in FIG. 1E. In one embodiment, the longitudinal axis of the spindle 2 is preferably coaxial with a longitudinal axis of the spindle conduit 9. In one embodiment, a central axis of the spindle inlet port 10 is parallel to, more preferably coaxial with, the longitudinal axis of the spindle conduit 9.

The distal end of the spindle 2 comprises a clamping face 13 in which one or a plurality of bolt holes 14 are situated. The clamping face 13 is separated by a gap 16 from a clamping plate 17, the clamping plate 17 having apertures corresponding to the bolt holes 14. One or a plurality of bolts 15 (e.g. four bolts (only one labeled), as shown in FIG. 1A and FIG. 1D) may be used to fixedly secure the clamping plate 17 to the clamping face 13, thereby securing the clamping plate 17 to the spindle 2. Although the use of bolts is illustrated, the clamping plate may be secured to the spindle in any suitable manner, for example with other types of pins (e.g. threaded pins such as screws or unthreaded pins), clamps and the like. As discussed in more detail below, the clamping plate 17 also serves to secure the barrel 3 on the spindle 2.

The barrel 20 may comprise a generally annular internal cavity 23 within which the barrel support portion 3 of the spindle 2 may be situated, the internal cavity 23 having an internal surface 24. The internal surface 24 of the internal cavity 23 and the radial surface 12 of the barrel support portion 3 of the spindle 2 are preferably contoured in a complementary fashion (e.g. both faces may be generally annular and smooth) to facilitate sealing engagement of the two surfaces 12, 24, and to permit rotation of the barrel 20 about the spindle 2 when the barrel 20 is not immovably secured to the spindle 2. The internal cavity 23 may comprise an integrated secondary high pressure chamber 25 configured as an annular channel situated around and in fluid communication with the spindle outlet ports 11 when the barrel 20 is mounted on the spindle 2, irrespective of angular position of the barrel 20 on the spindle 2. Sealing rings 28 (e.g. O-rings, back-up rings, etc.), one located proximally and one distally of the chamber 25, are situated between the internal surface 24 of the internal cavity 23 of the barrel 20 and the radial surface 12 of the barrel support portion 3 of the spindle 2 to further prevent fluid leakage out from between the two surfaces 24, 12.

The barrel 20 may further comprise a barrel conduit 29 extending between a barrel inlet port 30 and a barrel outlet port 31. The barrel inlet port 30 is in fluid communication with the chamber 25. The barrel outlet port 31 may be configured to receive a hydraulic hose, which will carry hydraulic fluid from the barrel outlet port 31 to a work tool downstream. The hydraulic hose may be secured to a fitting, preferably a straight fitting, in the barrel outlet port 31. The barrel outlet port 31 may be of any desired size, therefore the barrel outlet port 31 may be made larger or smaller than an outlet on the housing of typical hydraulic pumps available in the art, which provides greater flexibility in controlling fluid flow pressure to a work tool.

The barrel outlet port 31 may be situated on a barrel outlet face 32 of the barrel 20. The barrel outlet face 32 may be contoured in a complementary fashion to a face of a second pump block mountable on the barrel outlet face 32. In furtherance of this end, mounting apertures 36 (only one of four labeled) situated on the barrel outlet face 32 may be configured to receive and secure mounting pins from the second pump block, and an inlet port on the second pump block may be aligned with the barrel outlet port 31 to permit fluid flow from the barrel 20 into the second pump block. The second pump block may be mounted on the barrel 20 instead of the hydraulic hose, if desired, and the hydraulic hose may be fitted to the second pump block, for example via a fitting in an outlet of the second pump block.

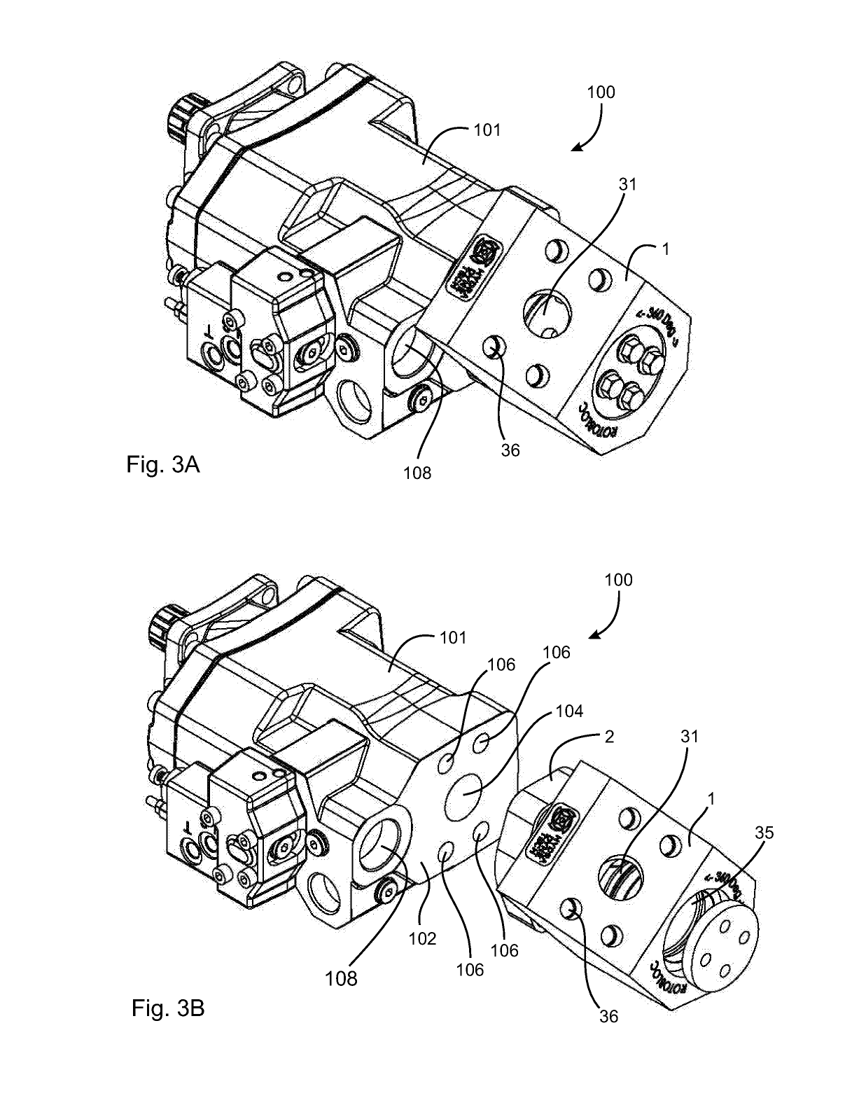

In operation, the pump block 1 is mounted on a housing of a hydraulic pump (see FIG. 3A for example) so that hydraulic fluid being pumped by the pump enters the spindle conduit 9 through the spindle inlet port 10. Hydraulic fluid enters through the spindle inlet port 10 and flows through the spindle conduit 9 at a specific angle with respect to a longitudinal axis X of the spindle 2, which is 0° in this embodiment as shown in the FIG. 1F (i.e. the fluid flow through the spindle inlet port 10 and spindle conduit 9 is parallel to the longitudinal axis X of the spindle 2). Hydraulic fluid in the spindle conduit 9 exits the spindle conduit 9 at a non-zero angle relative to the longitudinal axis X of the spindle 2 through the spindle outlet ports 11. Hydraulic fluid from the spindle outlet ports 11 enters the chamber 25 in the barrel 20 filling the chamber 25. From the chamber 25, the hydraulic fluid enters the barrel conduit 29 through the barrel inlet port 30 and exits the barrel conduit 29 into a hydraulic hose (or another block) through the barrel outlet port 31. As can be seen in the FIG. 1F, in the illustrated embodiment hydraulic fluid exiting the pump block 1 is flowing along a fluid flow axis B oriented at an angle BX (in this embodiment about 45°) with respect to the direction X of fluid flowing from the pump housing into the spindle fluid conduit 9.

As previously described, the angle formed between the direction of fluid flow into the spindle conduit and the direction of fluid flow out of the barrel outlet port may be generally any angle in a range of about 10-170°, preferably in a range of about 30-110°, for example in a range of about 30-90°. To provide for a different angle, a different barrel having a differently oriented barrel outlet port may be mounted on the spindle. The removability of the barrel permits interchangeability of barrels allowing a different barrel to be fitted on the spindle depending on the desired direction of fluid flow exiting from the pump for any given workplace situation.

In respect of the pump block 1, a central axis of the barrel outlet port 31 is oriented at an angle of about 45° with respect to direction of fluid flow from the pump housing through the spindle inlet port 10 into the spindle fluid conduit 9. In an embodiment where the barrel conduit 29 provides a straight fluid flow path from the barrel inlet port 30 to the barrel outlet port 31, a longitudinal axis of the spindle fluid conduit 9 is oriented at a 45° angle with respect to direction of fluid flow from the pump housing through the spindle inlet port 10. Additionally, especially where the pump block 1 is adapted to permit the mounting of a second pump block, the barrel outlet face 32 may be angled at an acute or obtuse angle with respect to other faces of the barrel 20. Further, the barrel outlet face 32 may be angled at an acute or obtuse angle with respect to an outlet face of the pump housing.

Being able to pump the hydraulic fluid out of the pump block at an angle with respect to the direction of fluid flow into the pump block helps distribute hydraulic fluid forces generally around the entire pump thereby reducing stresses on any given fitting. The likelihood of failure of any one fitting in the pump is consequently reduced.

As indicated above, the barrel 20 may be secured on the spindle 2 by the clamping plate 17. A distal end of the barrel 20 may comprise an annular indent 35 sized to receive the clamping plate 17. The clamping plate has perimetrical dimensions larger than perimetrical dimensions of the clamping face 13 of the spindle 2, therefore an outer portion 17′ of the clamping plate 17 extends radially beyond the clamping face 13. The indent 35 in the barrel 20 may comprise a longitudinally facing abutment surface 36 and a transversely facing abutment surface 37 to limit movement of the clamping plate 17 in the indent 35. The longitudinally facing abutment surface 36 is configured so that the abutment surface 36 extends distally beyond the clamping face 13 of the spindle 2 to provide the gap 16 between the clamping face 13 and the clamping plate 17. When the clamping plate 17 is secured to the clamping face 13 by the bolts 15, the outer portion 17′ of the clamping plate 17 engages the longitudinally facing abutment surface 36 thereby immovably securing (i.e. locking) the barrel 20 between the clamping plate 17 and the abutment surface 7 of the abutment portion 4 of the spindle 2. Engagement of a proximal end face 39 of the barrel 20 against the abutment portion 4 of the spindle 2, and engagement of the abutment surface 36 of the barrel 20 against the outer portion 17′ of the clamping plate 17 under compressive forces resulting from tightening of the bolts 15 provides sufficient friction to render the barrel 20 immovable on the spindle 2

Additionally, the bolts 15 and the gap 16 cooperate to permit pre-tensioning of the spindle 2. Tightening the bolts 15 both pushes the barrel 20 against the abutment portion 4 of the spindle 2 and pulls the spindle 2 toward the clamping plate 17 across the gap 16. The gap 16 is never closed, therefore clamping face 13 of the spindle 2 does not contact the clamping plate 17 and the bolts 15 may be tightened to produce any desired pre-tensioning force on the spindle 2. Desirably, the pre-tensioning force on the spindle 2 is at least equivalent to, but preferably exceeds, the total induced load on the hydraulic pump caused by hydraulic fluid pressure in the pump and any mechanical loads (e.g. hoses) on the pump. In practice, the pre-tensioning force is desirably at least three times the hydraulic fluid pressure in the spindle fluid conduit 9 multiplied by the surface area of a distal end 8 of the spindle fluid conduit 9 against which the fluid impacts. Because the spindle 2 is pre-tensioned in this manner, the spindle 2 does not experience the load induced by the hydraulic fluid pressure in the pump, thereby reducing stresses on the pump and any fittings thereon.

Loosening the bolts 15 releases the barrel 20 from immovable securement, permitting the barrel 20 to move on the spindle 2 (i.e. unlocks the barrel 20) Once free to move, the barrel 20 may be rotated through any desired angle about the spindle 2 to occupy a different angular position with respect to the spindle 2. Once the barrel 20 is in the desired angular position, the bolts 15 may be re-tightened so that the clamping plate 17 once again tightens the barrel 20 against the abutment portion 4 of the spindle 2 to prevent further rotation of the barrel 20. Removing the bolts 15 entirely permits removal of the barrel 20 from the spindle 2. Thus, the barrel 20 may be reversibly secured on the spindle 2 to permit fixed securement under operating conditions, while permitting rotation of the barrel 20 on the spindle 2 or removal of the barrel 20 from the spindle 2 under non-operating conditions. Other ways of removably and/or reversibly securing the barrel to the spindle may be envisioned, which permits immovable securement of the barrel on the spindle when the hydraulic pump is operating while permitting a change in the angular position of the barrel on the spindle, and/or the removal of the barrel from the spindle when the pump is not operating.

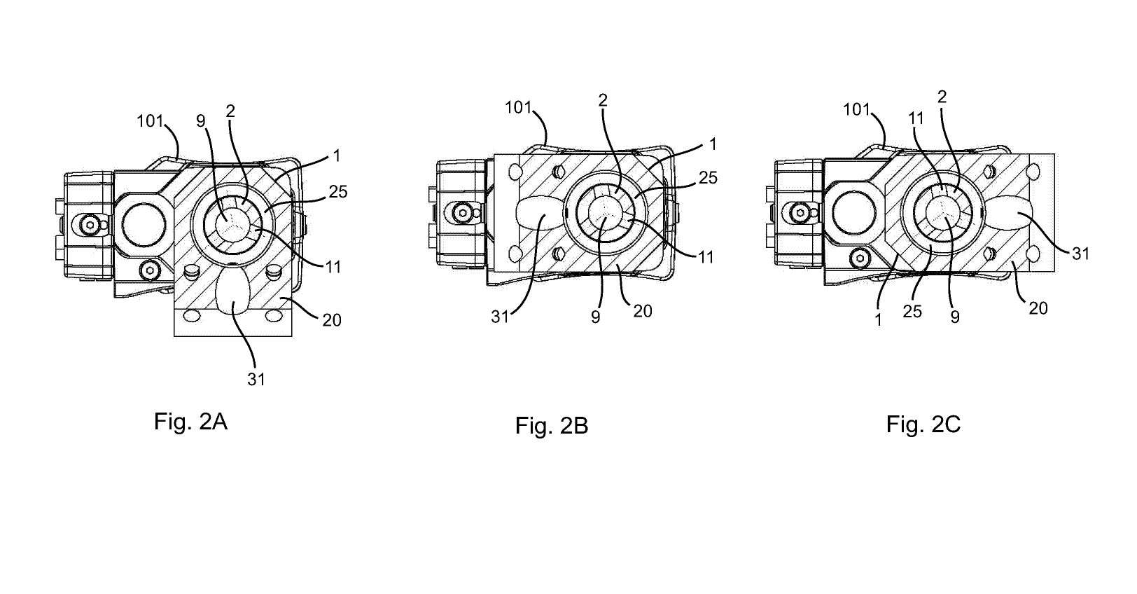

FIG. 2A, FIG. 2B and FIG. 2C illustrate three different configurations of the barrel 20 mounted on the spindle 2 with the barrel 20 occupying different angular positions on the spindle 2 and the central axis of the barrel outlet port 31 pointing in different radial directions as viewed from front of the pump block 1. The pump block 1 is mounted on a housing 101 of a hydraulic pump.

The ability to rotate the barrel on the spindle through any angle results in the barrel being able to occupy a plurality of different configurations. Consequently, a hydraulic hose fitted to the barrel outlet port can be more easily directed to a desired location. The angle is clearly defined based on the position of the hydraulic hose extending from the barrel outlet port, thereby reducing stress on any given fitting. Further, pumped hydraulic fluid pulsing through the pump block impacts the distal end of the spindle conduit. This force is transmitted through the distal end of the spindle on to the clamping plate, which redistributes the forces back through the barrel to the outlet face of the pump housing. Hydraulic forces are thereby distributed over a larger area compared with a conventional threaded elbow connection fitted directly to the fluid outlet in the pump housing, thereby reducing the likelihood of a given fitting failing. Thus, the present pump block provides the ability to direct hydraulic hoses to a desired location while reducing the likelihood of a given fitting failing.

With reference to FIG. 3A and FIG. 3B, a hydraulic pump 100 is illustrated comprising a housing 101 and the pump block 1, which may be mounted on the housing 101 as depicted in FIG. 3A. The housing 101 houses a pumping mechanism (not shown) configured to pump hydraulic fluid. Housings, pumping mechanisms and other parts of hydraulic pumps needed to pump hydraulic fluid are generally known in the art, and known hydraulic pumps may be adapted for use in the present invention. The housing 101 comprises a housing outlet face 102 with a housing outlet 104 therein. The pumping mechanism of the hydraulic pump 100 draws hydraulic fluid from a fluid reservoir (not shown) through a hydraulic hose (not shown) fitted to a housing inlet 108 on the housing 101. Hydraulic fluid entering the pump 100 through the housing inlet 108 is pumped out of the housing outlet 104 into the pump block 1. The housing outlet face 102 sealingly engages the spindle inlet face 5 of the spindle 2, with the housing outlet 104 aligning with the spindle inlet port 10 so that hydraulic fluid passing out of the housing outlet 104 enters the spindle conduit 9 through the spindle inlet port 10. The housing outlet face 102 and the spindle inlet face 5 are preferably contoured in a complementary fashion (e.g. both faces may be generally flat) to facilitate sealing engagement of the two faces 5, 102. An O-ring 19 (see FIG. 1E) disposed between the two faces 5, 102 around the housing outlet 104 and spindle inlet port 10 further prevents fluid leakage out from between the two faces 5, 102. In one embodiment, a central axis of the housing outlet 104 is coaxial with the central axis of the spindle inlet port 10.

The spindle 2 may be fixedly mounted on the housing 101 in either a removable or not removable manner, for example by pins (e.g. unthreaded pins, bolts, screws, etc.), clamps, welds and the like. For example, as shown in FIG. 3B, the housing outlet face 102 may comprise a plurality of apertures 106 (preferably threaded apertures) that accept and engage with the mounting pins 6 (preferably bolts or screws) protruding from the spindle inlet face 5. The pin-in-aperture arrangement facilitates proper alignment of the housing outlet 104 with the spindle inlet port 10 when the spindle 2 is mounted on the housing 101. The pin-in-aperture arrangement also facilitates demounting the pump block 1 from the housing 101.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A block for a fluid conveyance device, the block comprising:
a spindle mountable on an outlet face of a housing of a fluid conveyance device, the spindle having a spindle fluid conduit in fluid communication with a housing outlet on the outlet face of the housing; and,
a barrel mounted on the spindle, the barrel comprising a barrel fluid conduit in fluid communication with the spindle fluid conduit, the barrel fluid conduit having a fluid outlet port, the fluid outlet port having a central axis parallel to fluid flow through the fluid outlet port, the central axis of the fluid outlet port oriented at an angle in a range of about 10-170° with respect to direction of fluid flow from the housing of the fluid conveyance device into the spindle fluid conduit, the barrel mountable on the spindle in a plurality of configurations, the central axis of the fluid outlet port pointing in a different direction in each configuration of the barrel.

2. The block according to claim 1, wherein the barrel is rotatably mounted on the spindle.

3. The block according to claim 1, wherein the barrel is removably mounted on the spindle.

4. The block according to claim 1, wherein the spindle is pre-tensioned under a pre-tensioning force, the pre-tensioning force at least equivalent to a total induced load on the device, the total induced load arising at least in part from fluid pressure in the device and mechanical loads on the device.

5. The block according to claim 4, further comprising a locking plate reversibly securable to the spindle, the locking plate providing the pre-tensioning force when the locking plate is fixedly secured to the spindle.

6. The block according to claim 5, wherein the locking plate is fixedly securable to the spindle to immovably lock the barrel between the locking plate and an abutment portion of the spindle and the locking plate loosenable from the spindle to permit rotation of the barrel on the spindle.

7. The block according to claim 5, wherein the locking plate is removable from the spindle to permit removal of the barrel from the spindle.

8. The block according to claim 5, wherein the spindle comprises a distal face to which the locking plate is securable by threaded pins, the locking plate having an outer portion extending radially beyond a perimetrical edge of the distal face, the barrel secured between the outer portion of the locking plate and the abutment portion of the spindle when the locking plate is fixedly secured to the spindle.

9. The block according to claim 5, wherein the spindle and the locking plate are separated by a gap when the locking plate is fixedly secured to the spindle.

10. The block according to claim 1, wherein rotating the barrel on the spindle changes the configuration of the barrel to change an angular position of the fluid outlet port on the block.

11. The block according to claim 1, wherein the spindle comprises a proximal face having a spindle inlet port in fluid communication with the spindle conduit, the spindle inlet port configured to align with the housing outlet on the outlet face of the housing to fluidly communicate with the outlet face on the housing when the proximal face of the spindle abuts the outlet face of the housing.

12. The block according to claim 11, wherein the barrel comprises a barrel outlet face in which the fluid outlet port is situated, the barrel outlet face having an angle in a range of about 10-170° relative to the proximal face of the spindle.

13. A fluid conveyance device comprising the block as defined in claim 1.

14. A fluid conveyance device comprising:
a fluid conveying mechanism contained in a housing, the housing having a housing outlet for fluid situated on an outlet face of the housing; and,
a block comprising a spindle and a barrel,
the spindle mounted on the outlet face, the spindle having a spindle fluid conduit in fluid communication with the outlet,
the barrel mounted on the spindle, the barrel comprising a barrel fluid conduit in fluid communication with the spindle fluid conduit, the barrel fluid conduit having a fluid outlet port, the fluid outlet port having a central axis parallel to fluid flow through the fluid outlet port, the central axis of the fluid outlet port oriented at an angle in a range of about 10-170° with respect to direction of fluid flow through the housing outlet into the spindle fluid conduit, the barrel mountable on the spindle in a plurality of configurations, the central axis of the fluid outlet port pointing in a different direction in each configuration of the barrel.

15. The fluid conveyance device according to claim 13, which is a hydraulic pump or a hydraulic motor.

16. The fluid conveyance device according to claim 14, which is a hydraulic pump or a hydraulic motor.
